(19) United States
(12) Patent Application Publication
(10) Pub. No.: US 2026/0221023 A1
(43) Pub. Date: Jul. 30, 2026

(54) ALARM MANAGEMENT APPARATUS, ALARM MANAGEMENT METHOD, AND ALARM MANAGEMENT PROGRAM

(71) Applicant: Yokogawa Electric Corporation, Tokyo (JP)

(72) Inventors: Yusuke ONO, Tokyo (JP); Taketoshi SATOMURA, Tokyo (JP)

(21) Appl. No.: 19/158,256

(22) PCT Filed: Feb. 27, 2024
(86) PCT No.: PCT/JP2024/006985

§ 371 Date: Aug. 20, 2025

(30) Foreign Application Priority Data
Feb. 27, 2023 (JP) 2023-028462

(51) Int. Cl. G08B 29/12

(52) U.S. Cl. CPC G08B 29/126

(57) ABSTRACT

An alarm management apparatus includes a processor configured to receive a first alarm that is generated by a first device complying with a given standard and information on an alarm that is transmitted by a second device not complying with the given standard, generate a second alarm in a data form complying with the given standard based on the information on the alarm when the information on the alarm is received, and notify a given terminal device of the first alarm and the second alarm.

### TECHNICAL FIELD

The present invention relates to an alarm management apparatus, an alarm management method, and an alarm management program.

### BACKGROUND ART

In a plant control system, development of systems and rules serving as a base for operating and monitoring various devices in an integrated manner is in progress. Particularly, interfaces complying with OPC UA (Open Platform Communications Unified Architecture) that is a standard are becoming a main stream as common interfaces in the industry to which plant control systems relate.

### CITATION LIST

### Patent Literature

PTL 1: Japanese Laid-open Patent Publication No. 2006-318147

PTL 2: Japanese Laid-open Patent Publication No. 2015-138548

PTL 3: Japanese Laid-open Patent Publication No. 2022-177415

### SUMMARY OF INVENTION

### Technical Problem

In the plant control system, however, it is difficult to manage alarms of alarm generation resources at a wide variety of function levels in an integrated manner. For example, there are many cases where instruments at low cost and with narrowed functions are kept used in a plant, and it is not infrequent that a device in which an interface complying with OPC UA is not implemented intermingles in a plant control system.

The present invention was made in view of the above-described circumstances and it is an object of the present invention to manage alarms effectively.

### Solution to Problem

According to an aspect of the embodiments, an alarm management apparatus includes a receiver that receives a first alarm that is generated by a first device complying with a given standard and information on an alarm that is transmitted by a second device not complying with the given standard, a generator that generates a second alarm in a data form complying with the given standard based on the information on the alarm when the information on the alarm is received, and a notifying unit that notifies a given terminal device of the first alarm and the second alarm.

According to an aspect of the embodiments, an alarm management method in which a computer executes a process includes receiving a first alarm that is generated by a first device complying with a given standard and information on an alarm that is transmitted by a second device not complying with the given standard, generating a second alarm in a data form complying with the given standard based on the information on the alarm when the information on the alarm is received, and notifying a given terminal device of the first alarm and the second alarm.

According to an aspect of the embodiments, an alarm management program that causes a computer to execute a process includes receiving a first alarm that is generated by a first device complying with a given standard and information on an alarm that is transmitted by a second device not complying with the given standard, generating a second alarm in a data form complying with the given standard based on the information on the alarm when the information on the alarm is received, and notifying a given terminal device of the first alarm and the second alarm.

### Advantageous Effects of Invention

According to the present invention, there is an effect that it is possible to manage alarms effectively.

### BRIEF DESCRIPTION OF DRAWINGS

FIG. 1 is a diagram illustrating an example of a configuration of an alarm management system according to an embodiment.

FIG. 2 is a diagram illustrating Specific Example 1 of an alarm management system according to a reference technique.

FIG. 3 is a diagram illustrating Specific Example 2 of the alarm management system according to the reference technique.

FIG. 4 is a block diagram illustrating an example of a configuration of each device according to the embodiment.

FIG. 5 is a diagram illustrating an example of implementation of an alarm detection driver according to the embodiment.

FIG. 6 is a diagram illustrating an example of implementation of an alarm reception driver according to the embodiment.

FIG. 7 is a diagram illustrating an example of implementation of a normalization converter according to the embodiment.

FIG. 8 is a diagram illustrating Specific Example 1 of an alarm management process according to the embodiment.

FIG. 9 is a diagram illustrating Specific Example 2 of the alarm management process according to the embodiment.

FIG. 10 is a diagram illustrating Specific Example 3 of the alarm management process according to the embodiment.

FIG. 11 is a diagram illustrating Specific Example 4 of the alarm management process according to the embodiment.

FIG. 12 is a flowchart illustrating an example of a flow of the alarm management process according to the embodiment.

FIG. 13 is a diagram illustrating an example of a hardware configuration according to the embodiment.

### DESCRIPTION OF EMBODIMENTS

An alarm management apparatus, an alarm management method, and an alarm management program according to an embodiment of the present invention will be described in detail below with reference to the drawings. Note that the present invention is not limited by the embodiment described below.

### Embodiment

A configuration of and a process performed by an alarm management system 100, a configuration of and a process performed by each device of the alarm management system 100, a specific example of a process performed by an alarm management apparatus 10, and a flow of the process performed by the alarm management system 100 will be described in order and an effect of the embodiment will be described lastly.

### 1. Configuration of and Process Performed by Alarm Management System 100

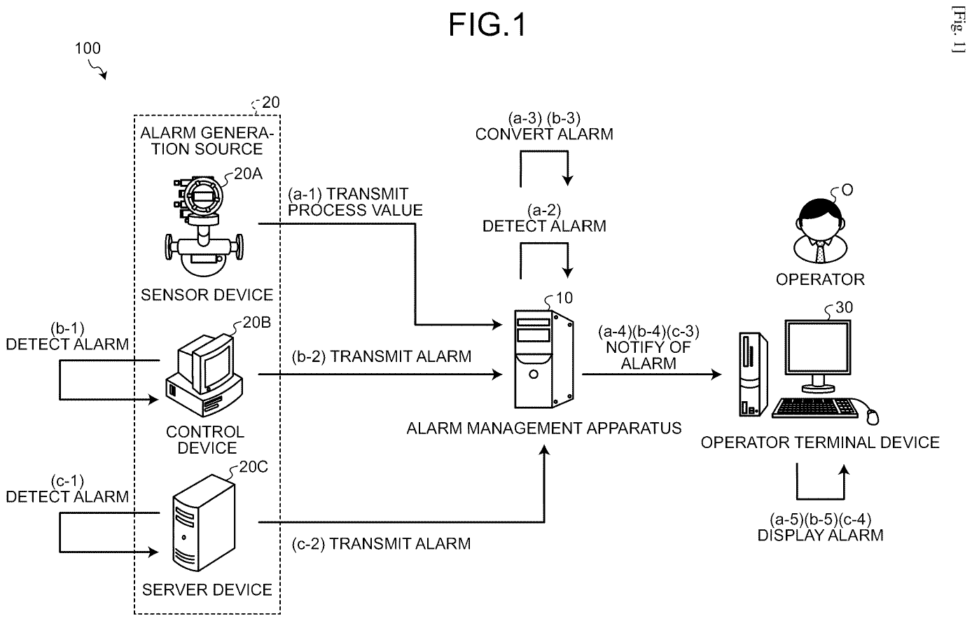

Using FIG. 1, the configuration of and the process performed by the alarm management system 100 according to the embodiment will be described in detail. FIG. 1 is a diagram illustrating an example of the configuration of the alarm management system 100 according to the embodiment. An example of a general configuration of the alarm management system 100, an example of the process performed by the alarm management system 100, and a problem of an alarm management system of a reference technique will be described in order and an effect of the alarm management system 100 will be described eventually. Note that the embodiment will be described, taking, as an example, factory production remote monitoring using a plant device that is a device set in a plant; however the embodiment does not limit the field of use of the device and is applicable to environmental measurement remote monitoring, such as power monitoring, wind power generation, water and sewerage monitoring, and river monitoring.

### 1-1. Example of General Configuration of Alarm Management System 100

An alarm management system 100 includes an alarm management apparatus 10, an alarm generation source 20 (a sensor device 20A, a control device 20B, and a server device 20C), and an operator terminal device 30. The alarm management apparatus 10, the alarm generation source 20, and the operator terminal device 30 are connected in a wired or a wireless manner via a given communication network (network) such that they can communicate with one another. The operator terminal device 30 is a terminal device that an operator O who manages a plant uses. Note that the alarm management system 100 illustrated in FIG. 1 may include a plurality of the alarm management apparatuses 10 or a plurality of the operator terminal devices 30.

The alarm generation source 20 will be described here. First of all, the sensor device 20A of the alarm generation source 20 is a device not implementing an alarm detecting function. For example, the sensor device 20A is a device, such as a temperature sensor, a pressure sensor, or a flow sensor, that collects a process value in a plant. Secondly, the control device 20B of the alarm generation source 20 is a device that implements the alarm detecting function. For example, the control device 20B is a controller, or the like, that detects an alarm indicating an abnormality in the plant, or the like, based on the process value in the plant. Thirdly, the server device 20C of the alarm generation source 20 is a device that implements the alarm detecting function complying with OPC UA A&C (Alarms and Conditions) that is a standard. For example, the server device 20C is an alarm server, or the like, that detects an alarm indicating an abnormality in the plant, or the like, based on the process value in the plant.

### 1-2. Example of General Process Performed by Alarm Management System 100

A general process performed by the alarm management system 100 described above will be described. Alarm management processes performed by the sensor device 20A, the control device 20B and the server device 20C serving as the alarm generation source 20 will be described below. It is also possible to execute the following processes in a different order. There may be a process to be omitted among the following processes.

### 1-2-1. Alarm Management Process Performed by Sensor Device 20A: First Alarm Management Process

First of all, the sensor device 20A transmits a process value (refer to FIG. 1(a-1)). For example, the sensor device 20A collects process values of temperature data, pressure data, flow data, etc., indicated by a subject to be monitored in the process of the plant and transmits the collected process values to the alarm management apparatus 10.

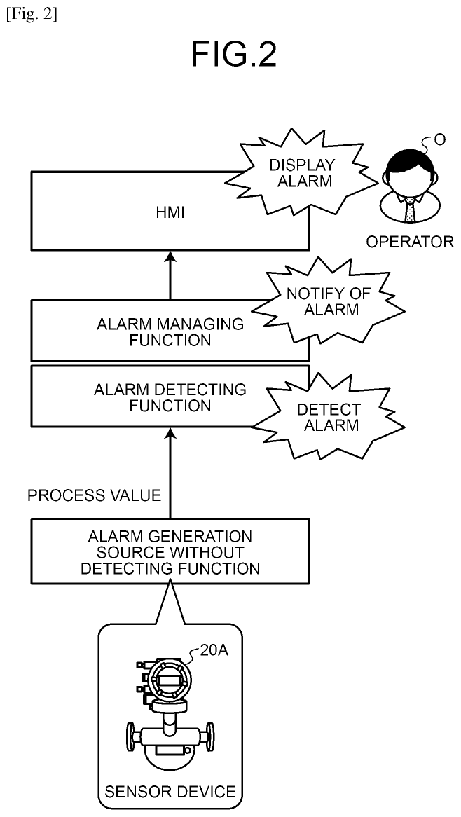

Secondly, the alarm management apparatus 10 detects an alarm (refer to FIG. 1 (a-2)). For example, when a process value that is received from the sensor device 20A exceeds a given threshold, the alarm management apparatus 10 detects an alarm indicating an abnormality in the plant and generates an alarm A indicating the content of the alarm.

Thirdly, the alarm management apparatus 10 converts the alarm (refer to FIG. 1 (a-3)). For example, the alarm management apparatus 10 converts the alarm A that is generated based on the process value received from the sensor device 20A into a data form complying with OPC UA A&C to generate an alarm A (A&C).

Fourthly, the alarm management apparatus 10 makes a notification of the alarm (refer to FIG. 1 (a-4)). For example, the alarm management apparatus 10 transmits the alarm A (A&C) obtained by conversion into the data form complying with OPC UA A&C to the operator terminal device 30 that the operator O uses.

Fifthly, the operator terminal device 30 displays an alarm (refer to FIG. 1 (a-5)). For example, the operator terminal device 30 displays the alarm A (A&C) that is received from the alarm management apparatus 10 on the monitor and notifies the operator O of occurrence of the abnormality in the plant, or the like.

By executing the above-described first alarm management process, the alarm management system 100 is able to manage alarms in a plant control system including a device not implementing the alarm detecting function as the alarm generation source 20.

### 1-2-2. Alarm Management Process Performed by Control Device 20B: Second Alarm Management Process

First of all, the control device 20B detects an alarm (refer to FIG. 1 (b-1)). For example, when a process value that is received from a device that is connected to the control device 20B exceeds a given threshold, the control device 20B detects an alarm indicating an abnormality in the plant, or the like, and generates an alarm B indicating the content of the alarm.

Secondly, the control device 20B transmits the alarm (refer to FIG. 1 (b-2)). For example, the control device 20B transmits an alarm B that is generated based on a process value that is received from the device that is connected to the control device 20B to the alarm management apparatus 10.

Thirdly, the alarm management apparatus 10 converts an alarm (refer to FIG. 1 (b-3)). For example, the alarm management apparatus 10 converts the alarm B that is received from the control device 20B into a data form complying with OPC UA A&C to generate an alarm B (A&C).

Fourthly, the alarm management apparatus 10 makes a notification of the alarm (refer to FIG. 1 (b-4)). For example, the alarm management apparatus 10 transmits the alarm B (A&C) obtained by conversion into the data form complying with OPC UA A&C to the operator terminal device 30 that the operator O uses.

Fifthly, the operator terminal device 30 displays an alarm (refer to FIG. 1 (b-5)). For example, the operator terminal device 30 displays the alarm B (A&C) received from the alarm management apparatus 10 on a monitor and notifies the operator O of occurrence of an abnormality in the plant, or the like.

By executing the above-described second alarm management process, the alarm management system 100 is able to manage alarms in the plant control system including, as the alarm generation source 20, a device implementing the alarm detecting function other than an alarm server complying with OPC UA A&C.

### 1-2-3. Alarm Management Process Performed by Server Device 20C: Third Alarm Management Process

First of all, the server device 20C detects an alarm (refer to FIG. 1 (c-1)). For example, when a process value that is received from a device that is connected to the server device 20C exceeds a given threshold, the server device 20C detects an alarm indicating an abnormality in the plant, or the like, and generates an alarm C (A&C) indicating the content of the alarm.

Secondly, the server device 20C transmits an alarm (refer to FIG. 1 (c-2)). For example, the server device 20C transmits the alarm C (A&C) that is generated in a data form complying with OPC UA A&C to the alarm management apparatus 10.

Thirdly, the alarm management apparatus 10 makes a notification of the alarm (refer to FIG. 1 (c-3)). For example, the alarm management apparatus 10 transmits the alarm C (A&C) that is received from the server device 20C to the operator terminal device 30 that the operator O uses.

Fourthly, the operator terminal device 30 displays an alarm (refer to FIG. 1 (c-4)). For example, the operator terminal device 30 displays the alarm C (A&C) received from the alarm management apparatus 10 on the monitor and notifies the operator O of occurrence of an abnormality in the plant, or the like.

By executing the above-described third alarm management process, the alarm management system 100 is able to manage alarms in the plant control system including an alarm server complying with OPC UA A&C as the alarm generation source 20.

### 1-3. Effect of Alarm Management System 100

The background of the plant control system and an overview and problems of the reference technique described in Patent Literatures 1 to 3 will be described and then an effect of the alarm management system 100 will be described below.

### 1-3-1. Background of Plant Control System

In recent years, large scales of and remote control on plant control systems have become more popular and there has been an increasing number of cases where instruments from a plurality of venders are mixed in the same system. Such instrument devices are at different function levels and communication interfaces that are used for external communication are different in some cases and therefore treatment of data and alarms tends to be complicated.

On the other hand, development of systems and rules serving as a base for operating and monitoring various devices in an integrated manner is in progress and OPC UA interfaces are becoming a main stream as common interfaces for vender devices to communicate in the industry to which the plat control system relates. With the above-described stream, instruments supported by OPC UA interfaces has increased rapidly, and products supporting OPC UA interfaces are also increasing on the side of operation systems and the side of monitoring systems. On the contrary to this, however, there are also many cases where instruments at low cost and with narrowed functions are also kept used in a plant, and it is not infrequent that an instrument in which an OPC UA interface is not implemented intermingles in a system. Particularly, there are few instruments implementing the alarm managing function in inexpensive instruments and there are more few instruments in which an OPC UA A&C model is implemented.

### 1-3-2. Overview of Alarm Management System According to Reference Technique

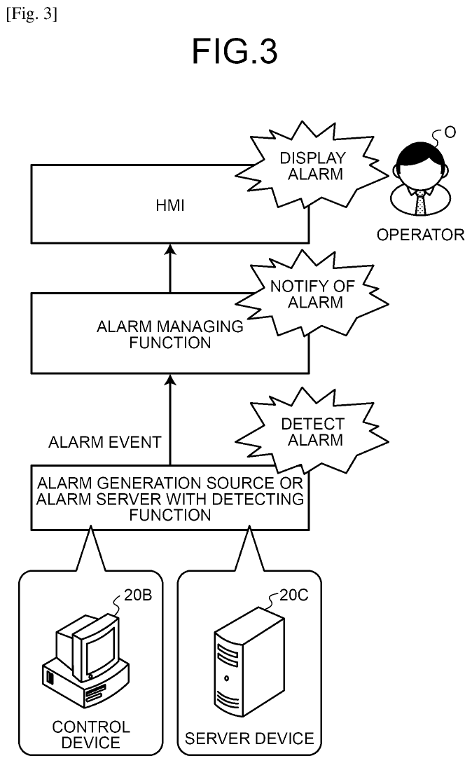

Using FIG. 2 and FIG. 3, an overview of an alarm management system according to a reference technique will be described. FIG. 2 and FIG. 3 are diagrams illustrating a specific example of the alarm management system according to the reference technique. As for the alarm management system according to the reference technique in which alarm detection and notifying the operator O of an alarm are executed, a basic configuration of the alarm management system will be described and a problem in Specific Example 1 that is an alarm management system targeting an alarm generation source without a detecting function and a problem in Specific Example 2 that is an alarm management system targeting an alarm generation source with the detecting function or an alarm server will be described in order.

### 1-3-2-1. Basic Configuration of Alarm Management System According to Reference Technique

First of all, the alarm generation source 20 will be described. The alarm generation source 20 is a generic name of devices or systems that control data and alarm events serving as causes of alarms. There are, as the alarm generation source 20, one that itself sets an alarm generation condition, that detects an alarm by itself evaluating the condition, and that makes a notification of the result of the detection as an alarm event to the outside and one that itself does not detect an alarm and that makes a notification of only data serving as a cause of the alarm. In the latter case, an external device or system has to take over detection of an alarm to generate an alarm.

Secondly, the alarm managing function will be described. The alarm managing function is a general function for treating alarms that the plant control system has. When the alarm generation source 20 does not have the detecting function, the alarm managing function evaluates acquired process values, etc., itself detects an alarm, and controls the detection and the generated alarm. When a sophisticated device with the alarm detecting function is targeted, the device converts received alarm information into a format of an alarm that itself is able to control and manages the alarm.

Thirdly, a HMI (Human Machine Interface) will be described. The HMI has a function of collecting a generated alarm from the alarm managing function and displaying an alarm message and a current alarm status. The operator O is able to know a notification of an alarm and a current alarm status via the HMI. In this case, a function enabling the operator O to treat alarms in an integrated manner not depending on the type and features of the alarm generation source 20 is desired.

### 1-3-2-2. Problem in Specific Example 1 of Alarm Management System According to Reference Technique

Using FIG. 2, a problem in Specific Example 1 that is an alarm management system targeting the alarm generation source 20 without the detecting function, such as the sensor device 20A, will be described.

Specific Example 1 illustrated in FIG. 2 has a configuration that is often seen in SCADA (Supervisory Control And Data Acquisition) products that have to be operated with various instruments being connected thereto. As described above, many instruments including inexpensive ones sometimes do not have the alarm managing function or have unique alarm managing functions and have alarm mechanisms not complying with a standard, such as ISA18.2 or IEC62862. In an environment where devices having such a wide variety of alarm policies are mixed, it is difficult to manage alarms in an integrated manner on an operation function side or a monitoring function side. For this reason, as in the configuration illustrated in FIG. 2, the side of the plant control system is in charge of all alarm detection and the plant control system implements an alarm detection logic for each low-order device (or communication interface).

In Specific Example 1, because the plant control system is a system that detects an alarm from process values and a status of communication with instruments, any instrument capable of acquiring data, such as sensor values, is able to treat alarms in an integrated manner with respect to any device or communication interface.

Specific Example 1, however, is dedicated to treating alarms in a generic manner and therefore it is difficult to treat important alarm information, such as the time of detection of an alarm that is generated by a sophisticated instrument like one having the alarm managing function. Furthermore, in Specific Example 1, because evaluation on the detection logic is executed at constant timing on the side of the control system, when a process value exceeds an upper limit instantaneously, detection of an alarm sometimes fails. Such a failure as that described above in Specific Example 1 has a possibility of violation of a rule, such as FDA (Food and Drug Administration), and thus can be a fatal failure of the product.

### 1-3-2-3. Problem in Specific Example 2 of Alarm Management System According to Reference Technique

Using FIG. 3, a problem in Specific Example 2 that is an alarm management system targeting the alarm generation source 20 having the detecting function, such as the control device 20B or the server device 20C, will be described.

Specific Example illustrated in FIG. 3 targets instruments that are connected to a plant control system and that have the alarm detecting function or an OPC Classic A&E server, an OPC UA server, and the like, and has a configuration of receiving alarm events that are detected by these devices, generating alarms based in the information, and notifying the HMI. In other words, different from Specific Example 1, Specific Example 2 is a system that itself does not have the alarm detecting function and that itself directly receives alarms generated by low-order devices.

Specific Example 2 is able to use an alarm that is transmitted by a device having the alarm detecting function. In other words, Specific Example 2 is able to use an accurate timestamp that is detected by the device and raw data, such as alarm importance according to the type of the alarm. Furthermore, Specific Example 2 leaves detection of an alarm to the alarm generation source 20 and accordingly enables generation of an alarm by driving an event, which leads to a reduction in the load of the system and the communication load and a reduction in failing to receive an alarm.

In Specific Example 2, however, devices having the function of detecting and opening an alarm are limited to sophisticated instruments and devices implementing OPC UA A&C and inexpensive devices do not have the function in many cases. In Specific Example 2, it is necessary to implement the detection logic via an OPC UA server, or the like, in between in order to treat an alarm of such an inexpensive device as that described above. Thus, in Specific Example 2, realizing the detection logic on the side of the OPC UA server leads to complication in a module configuration, such as preparation of an extra PC (Personal Computer).

### 1-3-3. Background of Alarm Management System 100

The alarm management system 100 according to the embodiment realizes treatment of alarms in an integrated manner in a complicated environment where instruments at different function levels like those described above are mixed. The background of which consciousness should be gained for the above-described realization below will be described below.

As described above, it is the fact that polarization of the alarm functions that instruments have progresses and instruments that are inexpensive and that have limited purposes and functions and sophisticated instruments that are sophisticated and that themselves detect alarms and manage the alarms are mixed. On the other hand, instruments implementing an OPC UA A&C function from the trend of openness and general-purpose OPC UA servers capable of communicating with various instruments have appeared and thus integrated alarm management is difficult more.

In order to solve the above-described problem, it is necessary to be conscious of changes in the current environment of plants, etc., around plant control systems. In recent years, cloud systems and modes in which a plurality of sites are controlled centrally in a remote location are increasing. In the above-described environment, a secure and open communication system should be employed. Because of the above-described situation, it is necessary to be conscious of arrangement of systems and devices.

In light of the recent trend and the background of the field, the alarm management system 100 makes it possible to realize a system of a plant control system that enables the operator to execute integrated alarm management in the environment where devices at a variety of function levels are mixed.

### 1-3-4. Overview of Alarm Management System 100

In the alarm management system 100, first of all, when data that is collected by the sensor device 20A that does not have the detecting function and that is the alarm generation source 20 is received, the alarm management apparatus 10 generates an alarm A based on the received data, converts the generated alarm A into a data form complying with OPC UA A&C and notifies the operator terminal device 30 of the converted alarm A (A&C).

Secondly, when an alarm B that is generated by the control device 20B that has an alarm detecting function not complying with OPC UA A&C and that is the alarm generation source 20 is received, the alarm management apparatus 10 converts the received alarm B into a data form complying with OPC UA A&C and notifies the operator terminal device 30 of the converted alarm B (A&C).

Thirdly, when an alarm C (A&C) in a data form complying with OPC UA A&C that is generated by the server device 20C complying with OPC UA A&C is received, such as an alarm server, the alarm management apparatus 10 notifies the operator terminal device 30 of the received alarm C (A&C).

### 1-3-5. Effect of Alarm Management System 100

The alarm management system 100 enables integration of treatment of alarms of a wide variety of instruments at low cost. In other words, in the environment where instruments and systems at different function levels are mixed like that described above, the alarm management system 100 is able to realize management of a wide variety of alarms at low cost. Specifically, the alarm management system 100 is able to realize the following aspects.

First of all, in the alarm management system 100, because an alarm detection driver and an alarm reception driver can be treated in a generic manner for each interface, when the drivers are implemented once, the drivers can be operated continuously in any environment. Secondly, in the alarm management system 100, because the alarm managing function always only have to be conscious of the OPC UA A&C model, development at low cost can be expected. Thirdly, in the alarm management system 100, as for the alarm managing function, alarm forms are integrated and accordingly an alarm analyzing function or an alarm analytics function is implemented easily.

Accordingly, the alarm management system 100 makes it possible to manage alarms effectively in the plant control system.

### 2. Configuration of and Process Performed by Each Device of Alarm Management System 100

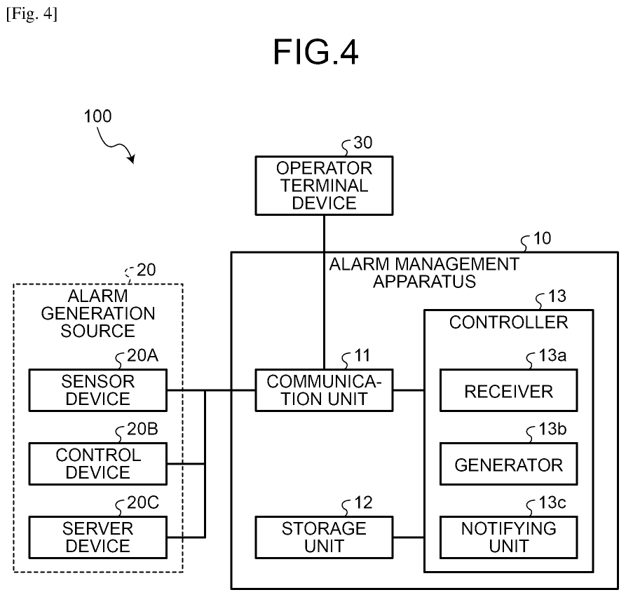

Using FIG. 4, a functional configuration of the alarm management apparatus 10 of the alarm management system 100 illustrated in FIG. 1 will be described. FIG. 4 is a block diagram illustrating an example of a configuration of each device of the alarm management system 100 according to the embodiment. An example of the general configuration of the alarm management system 100 according to the embodiment will be described and then an example of the configuration of and an example of the process performed by the alarm management apparatus 10, an example of a configuration and an example of the process performed by the alarm generation source 20, and an example of a configuration and an example of a process performed by the operator terminal device 30 will be described below.

### 2-1. Example of General Configuration of Alarm Management System 100

Using FIG. 4, the example of the general configuration of the alarm management system 100 illustrated in FIG. 1 will be described. As illustrated in FIG. 4, the alarm management system 100 includes the alarm management apparatus 10, the alarm generation source 20 (the sensor device 20A, the control device 20B, and the server device 20C), and the operator terminal device 30. The alarm management apparatus 10 is connected to the alarm generation source 20 and the operator terminal device 30 are connected via a given communication network such that they can communicate with one another.

### 2-2. Example of Configuration of and Process Performed by Alarm Management Apparatus 10

Using FIG. 2, the example of the configuration of and the example of the process performed by the alarm management apparatus 10 will be described. The alarm management apparatus 10 includes a communication unit 11, a storage unit 12, and a controller 13. Note that the alarm management apparatus 10 may include an input unit (for example, a keyboard, a mouse, or the like) that receives various types of operations from a manager of the alarm management apparatus 10, or the like, and a display unit for displaying various types of information (for example, a liquid crystal display, or the like).

### 2-2-1. Communication Unit 11

The communication unit 11 is in charge of data communication with other devices. For example, the communication unit 11 performs data communication with each communication device via a router, or the like. The communication unit 11 is capable of data communication with a terminal device of an operator not illustrated in the drawing.

### 2-2-2. Storage Unit 12

The storage unit 12 stores various types of information that is referred to when the controller 13 operates and various types of information that is acquired when the controller 13 operates. The storage unit 12, for example, can be realized using a semi-conductor memory device, such as a RAM (Random Access Memory) or a flash memory, or a storage device, such as a hard disk or an optical disk. The storage unit 12 is set inside the alarm management apparatus 10 according to the example in FIG. 4; however, the storage unit 12 may be set outside the alarm management apparatus 10 or a plurality of storage units may be set.

### 2-2-3. Controller 13

The controller 13 is in charge of general control on the alarm management apparatus 10. The controller 13 includes a receiver 13a, a generator 13b, and a notifying unit 13c. The controller 13, for example, is realized using an electric circuit, such as a CPU (Central Processing Unit) or a MPU (Micro Processing Unit), or an integrated circuit, such as an ASIC (Application Specific Integrated Circuit) or a FPGA (Field Pro-grammable Gate Array),

### 2-2-3-1. Receiver 13a

The receiver 13a receives various types of information. The receiver 13a stores the received various types of information in the storage unit 12. For example, the receiver 13a receives a first alarm that is generated by a first device complying with a given standard. A specific example of the standard will be described. The receiver 13a receives an alarm C (A&C) in a data form complying with OPC UA A&C that is generated by the server device 20C complying with OPC UA A&C.

The receiver 13a receives information on the alarm that is transmitted by a second device not complying with the given standard. A specific example of the information on the alarm will be described. The receiver 13a is a second device not complying with OPC UA A&C and receives data that is collected by the sensor device 20A without the alarm detecting function. The receiver 13a receives an alarm B that is generated by the control device 20B that is the second device not complying with OPC UA A&C and that has the alarm detecting function.

The receiver 13a receives a second alarm that is generated by the generator 13b to be described below. A specific example of the second alarm will be described. The receiver 13a receives an alarm A (A&C) in a data form complying with OPC UA A&C that is generated by the generator 13b based on data that is collected by the sensor device 20A that is the second device not complying with OPC UA A&C and that does not have the alarm detecting function. The receiver 13a also receives an alarm B (A&C) obtained by the generator 13b by converting the alarm B generated by the control device 20B that is the second device not complying with OPC UA A&C and that has the alarm detecting function into a data form complying with OPC UA A&C.

The receiver 13a also receives various types of information via the alarm reception driver complying with a given standard. For example, the receiver 13a receives a first alarm via the alarm reception driver complying with the given standard. The receiver 13a also receives information on the alarm via the alarm reception driver complying with the given standard. The receiver 13a also receives the second alarm via the alarm reception drive complying with the given standard.

### 2-2-3-2. Generator 13b

The generator 13b generates various types of information. Note that the generator 13b may store the generated various types of information in the storage unit 12. For example, when information on an alarm is received, the generator 13b generates a second alarm in a data form complying with the given standard based on the information on the alarm.

In other words, the generator 13b generates a second alarm based on data that is collected by the second device without the alarm detecting function. In this case, when data that is collected by the second device without the alarm detecting function is received and the data exceeds a given threshold, the generator 13b detects an alarm via the alarm detection driver complying with the given standard and the generator 13b generates a second alarm by converting the detected alarm into a data form complying with the given standard via a normalization converter complying with the given standard.

A specific example will be described. When a process value collected by the sensor device 20A that is the second device not complying with OPC UA A&C and that does not have the alarm detecting function is received and the process value exceeds the given threshold, the generator 13b detects an alarm via the alarm detection driver and generates an alarm A (A&C) based on the sensor device 20A by converting the detected alarm into a data form complying with OPC UA A&C via the normalization converter complying with OPC UA A&C.

The generator 13b generates a second alarm by converting an alarm that is generated by the second device having the alarm detecting function into a data form complying with the given standard. When the alarm that is generated by the second device having the alarm detecting function is received, the generator 13b generates a second alarm by converting the received alarm into a data form complying with the given standard via the normalization converter complying with the given standard.

A specific example will be described. When an alarm B that is generated by the control device 20B that is the second device not complying with OPC UA A&C and that has the alarm detecting function is received, the generator 13b generates an alarm B (A&C) based on the control device 20B by converting the received alarm B into a data form complying with OPC UA A&C via the normalization converter complying with OPC UA A&C.

### 2-2-3-3. Notifying Unit 13c

The notifying unit 13c makes a notification of various types of information. For example, the notifying unit 13c notifies a given terminal device of the first alarm that is generated by the first device complying with the given standard. The notifying unit 13c notifies the given terminal device of the second alarm that is generated by the generator 13b.

A specific example will be described. The notifying unit 13c notifies the operator terminal device 30 used by the operator O who manages the plant of the alarm C (A&C) in the data form complying with OPC UA A&C that is generated by the server device 20C complying with OPC UA A&C. The notifying unit 13c also notifies the operator terminal device 30 of the alarm A (A&C) that is generated by the generator 13b based on the process value collected by the sensor device 20A that is the second device not complying with OPC UA A&C and that does not have the alarm detecting function. The notifying unit 13c also notifies the operator terminal device 30 of the alarm B (A&C) that is generated by the generator 13b based on the alarm B that is generated by the control device 20B that is the second device not complying with OPC UA A&C and that has the alarm detecting function.

The notifying unit 13c makes a notification to the given terminal device on which the first alarm and the second alarm are displayed via an alarm notification interface complying with the given standard.

A specific example will be described. The notifying unit 13c makes a notification to the operator terminal device 30 on which the alarm C (A&C) based on the server device 20C is displayed via the alarm notification interface complying with OPC UA A&C. The notifying unit 13c also makes a notification to the operator terminal device 30 on which the alarm A (A&C) based on the sensor device 20A is displayed via the alarm notification interface complying with OPC UA A&C. The notifying unit 13c also makes a notification to the operator terminal device 30 on which the alarm B (A&C) based on the control device 20B is displayed via the alarm notification interface complying with OPC UA A&C.

### 2-3. Example of Configuration of and Process Performed by Alarm Generation Source 20

Using FIG. 4, the example of the configuration of and the example of the process performed by the alarm generation source 20 will be described. The alarm generation source 20 includes the sensor device 20A, the control device 20B, and the server device 20C.

### 2-3-1. Sensor Device 20A

The sensor device 20A is a device without the alarm detecting function among the second devices not complying with the given standard (example: OPC UA A&C) and collects data. For example, the sensor device 20A is a device, such as a temperature sensor, a pressure sensor, or a flow sensor, collects process values, such as temperature data, pressure data, and flow data in the plant, and transmits the collected process values to the alarm management apparatus 10.

### 2-3-2. Control Device 20B

The control device 20B is a device that has the alarm detecting function among the second devices not complying with the given standard (example: OPC UA A&C) and generates the alarm B. For example, the control device 20B is a device, such as a controller, and, when the process value in the plant exceeds the given threshold, generates the alarm B in the data form different from the data form complying with the given standard and transmits the generated alarm B to the alarm management apparatus 10.

### 2-3-3. Server Device 20C

The server device 20C is the first device complying with the given standard (example: OPC UA A&C) and generates the first alarm. For example, the server device 20C is a device, such as an alarm server, and, when the process value in the plant exceeds the given threshold, generates the alarm C (A&C) in the data form complying with the given standard and transmits the generated first alarm to the alarm management apparatus 10.

### 2-4. Example of Configuration of and Process Performed by Operator Terminal Device 30

Using FIG. 4, the example of the configuration of and the example of the process performed by the operator terminal device 30 will be described. For example, the operator terminal device 30 is a browsing terminal device that the operator O who manages the plant to which a plant control system has been introduced or for which introduction of a plant control system has been considered owns.

The operator terminal device 30 displays the first alarm and the second alarm of which the operator terminal device 30 is notified by the notifying unit 13c of the alarm management apparatus 10.

A specific example will be described. The operator terminal device 30 displays, as the first alarm, the alarm C (A&C) based on the server device 20C of which the operator terminal device 30 is notified by the notifying unit 13c of the alarm management apparatus 10. The operator terminal device 30 also displays, as the second alarm, the alarm A (A&C) based on the sensor device 20A of which the operator terminal device 30 is notified by the notifying unit 13c of the alarm management apparatus 10. The operator terminal device 30 also displays, as the second alarm, the alarm B (A&C) based on the control device 20B of which the operator terminal device 30 is notified by the notifying unit 13c of the alarm management apparatus 10.

### 3. Specific Example of Each Process Performed by Alarm Management Apparatus 10

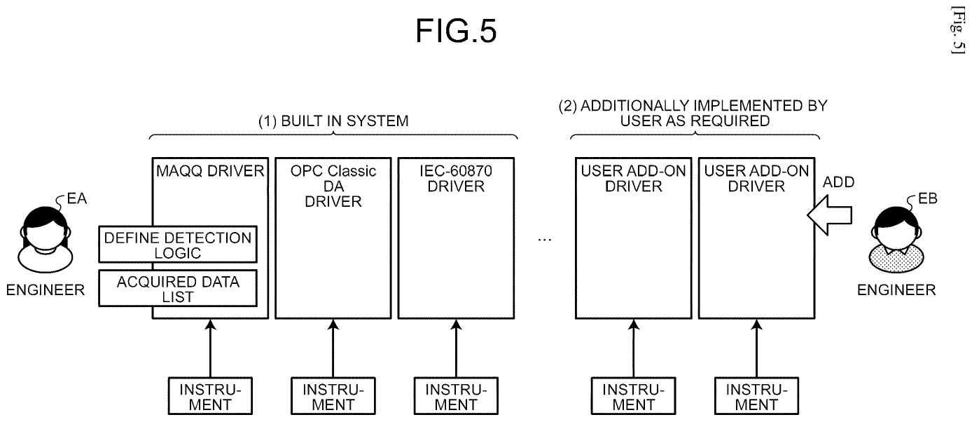

Using FIGS. 5 to 11, a specific example of each process performed by the alarm management apparatus 10 according to the embodiment will be described. A basic configuration of the alarm management system 100 according to the embodiment will be described and then an example of implementation of the driver and converter of the alarm management apparatus 10 and a specific example of the alarm management process according to the embodiment will be described below.

### 3-1. Basic Configuration of Alarm Management System 100 According to Embodiment

As for the basis configuration of the alarm management system 100 according to the embodiment, the alarm generation source 20, the alarm detection driver, the alarm reception driver, the alarm managing function, and the OPC UA A&C normalization converter will be described in order below.

### 3-1-1. Alarm Generation Source 20

First of all, the alarm generation source 20 according to the embodiment will be described below. The alarm generation source 20 is classified into the following three types according to the properties.

### 3-1-1-1. Alarm Generation Source without Detecting Function

The alarm generation source without the detecting function is an instrument that does not have the alarm detecting function and that has the narrowed functions. In the alarm management system 100, for the alarm generation source without the detecting function, the alarm detection logic is implemented on the side of the system via the alarm detection driver.

### 3-1-1-2. Alarm Generation Source with Detecting Function (Other than OPC UA Server)

After receiving an alarm, the alarm generation source with the detecting function (other than an OPC UA server) automatically converts information of the alarm into an OPC UA A&C model via the alarm reception converter.

### 3-1-1-3. OPC UA Server

The OPC UA server has the OPC UA A&C function, itself generates an alarm from the interface thereof and makes a notification of the alarm. In this case, the alarm management system 100 is able to receive the alarm directly via the OPC UA interface. The alarm generated herein need not be converted into an OPC UA A&C model and therefore it is possible to acquire the information contained in the alarm directly.

### 3-1-2. Alarm Detection Driver

Secondly, the alarm detection driver according to the embodiment will be described. The alarm detection driver is a driver that targets the alarm generation source 20 without the detecting function and that is for detecting an alarm by itself by collecting a process value serving as an element for alarm generation determination, etc., from the alarm generation source 20, and constantly making an evaluation. A user makes a data collecting setting for detection, thereby enabling detection of any given alarm. The detected alarm is passed to the side of a high-order OPC UA A&C model normalization converter via the interface that is opened by the converter and is converted into an OPC UA A&C model.

### 3-1-3. Alarm Reception Driver

Thirdly, the alarm reception driver according to the embodiment will be described. The alarm reception driver is a driver that targets the alarm generation source 20 having the detecting function other than an OPC UA server and that is for receiving an alarm event from the alarm generation source 20. The received alarm event is passed to the side of the high-order OPC UA A&C model normalization converter via the interface that is opened by the converter and is converted into an OPC UA A&C model. The user is able to engineer how an alarm is converted.

### 3-1-4. Alarm Managing Function

Fourthly, the alarm managing function according to the embodiment will be described. The alarm managing function is a function including the alarm reception driver of the OPC UA client and that is for treating alarms in an integrated manner. Alarms relating to the alarm generation source 20 serving as a low-order target are all converted into an OPC UA A&C model and are passed. In other words, the alarm managing function need not be conscious of the difference of the low-order alarm generation source 20 and is able to treat alarms in an integrated manner.

### 3-1-5. OPC UA A&C Normalization Converter

Fifthly, the OPC UA A&C normalization converter according to the embodiment will be described. The OPC UA A&C normalization converter is a module incorporating a logic that reads the results of conversion that are transmitted from the alarm reception driver and the detection driver, respectively, and that converts the results into an OPC UA A&C model. The integrated alarm notification interface is opened to the low-order driver and the driver makes a notification of an alarm according to the interface and thus it is possible to implement the OPC UA A&C normalization converter without being conscious of the OPC UA A&C model on the side of the driver. In the OPC UA A&C normalization converter, the OPC UA server interface for notifying the high-order alarm managing function of alarm information is implemented.

### 3-2. Example of Implementation of Alarm Detection Driver

Using FIG. 5, the alarm detection driver that is implemented in the alarm management apparatus 10 according to the embodiment will be described. FIG. 5 is a diagram illustrating the example of implementation of the alarm detection driver according to the embodiment.

The alarm detection driver is implemented for each interface for data acquisition and is treated in a generic manner. The user is able to define data to be acquired and a detection logic for each driver. As illustrated in FIG. 5(1), an engineer EA who is a user is able to define data to be acquired and a detection logic for each of drivers, such as a MAQQ driver, an OPC Classic DA driver, and an IEC-60870 driver, that are built in the system.

The alarm detection driver allows the user to make an additional implementation for an instrument that is connected with a not-supporting interface and additionally implement a driver freely. As illustrated in FIG. 5(2), an engineer EB who is a user is able to add a user add-on driver as required.

### 3-3. Example of Implementation of Alarm Reception Driver

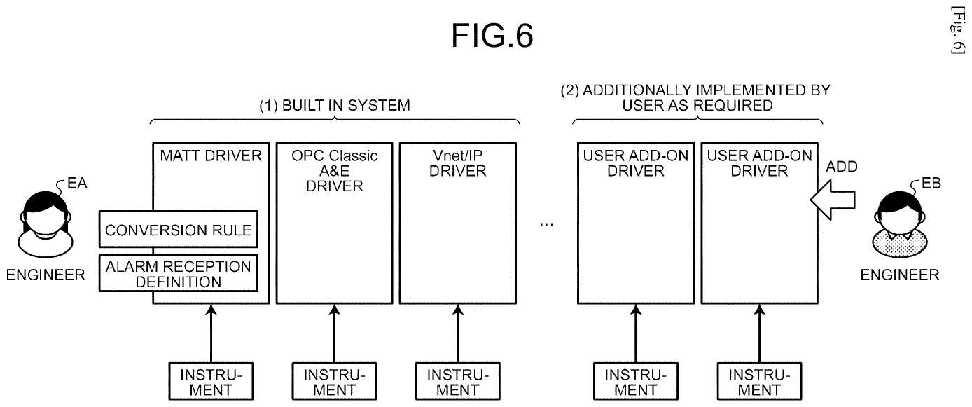

Using FIG. 6, the alarm reception driver that is implemented in the alarm management apparatus 10 according to the embodiment will be described. FIG. 6 is a diagram illustrating an example of implementation of the alarm reception driver according to the embodiment.

The alarm reception driver is implemented for each interface for data acquisition and is treated in a generic manner. The user is able to define an alarm to be received and define a rule for converting a received alarm for each driver. As illustrated in FIG. 6(1), an engineer EA who is a user is able to define an alarm to be received and define a rule for converting a received alarm for each of drivers, such as a MATT driver, an OPC Classic A&E driver, and a Vnet/IP driver, that are built in the system.

The alarm reception driver allows the user to make an additional implementation for an instrument that is connected with a not-supporting interface and additionally implement a driver freely. As illustrated in FIG. 6(2), the engineer EB who is a user is able to add a user add-on driver as required.

### 3-4. Example of Implementation of OPC UA A&C Normalization Converter

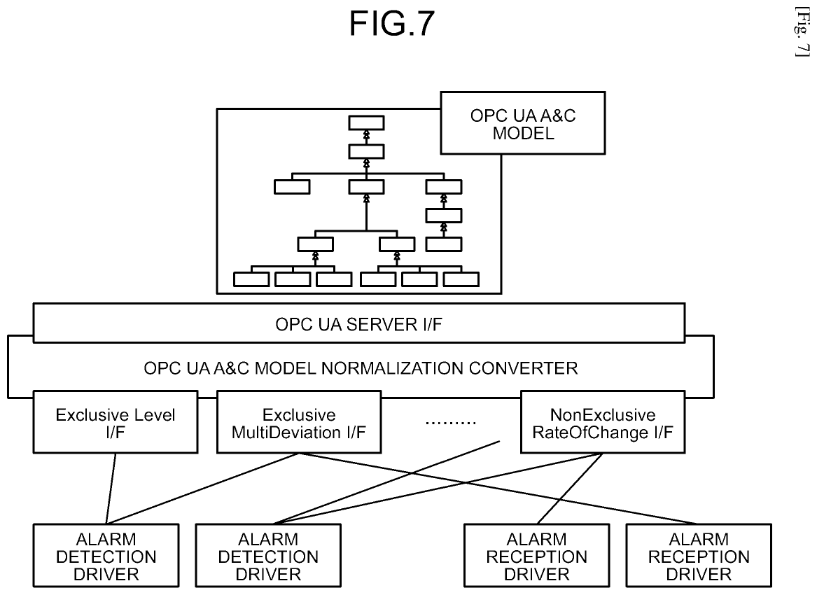

Using FIG. 7, the OPC UA A&C normalization converter that is implemented in the alarm management apparatus 10 according to the embodiment will be described. FIG. 7 is a diagram illustrating an example of implementation of the normalization converter according to the embodiment.

The OPC UA A&C normalization converter is a module that implements an OPC UA server internally and opens a unified interface for acquiring information when an OPC UA A&C model is configured to a lower-order driver.

Both the alarm detection driver and the alarm reception driver pass alarms to the OPC UA A&C normalization converter according to the open unified interface. Various types of interfaces implement an interface for alarm generation per event model according to OPC UA A&C that is defined by the OPC Foundation and, by using these interfaces (I/F), the drivers are able to generate alarms without being conscious of details of the structure of the OPC UA A&C model. As illustrated in FIG. 7, various types of drivers pass alarms to the OPC UA A&C normalization converter according to the interfaces, such as an Exclusive Level I/F, an Exclusive Multi-Deviation I/F, and a NonExclusive RateOfChange I/F.

### 3-5. Specific Example 1 of Alarm Management Process According to Embodiment

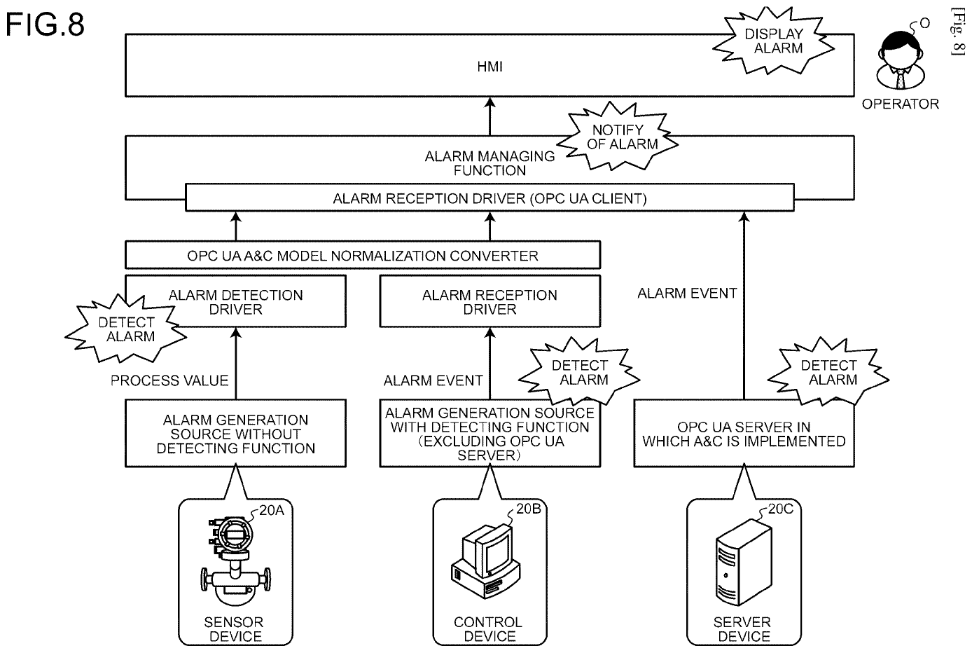

Using FIG. 8, a basis alarm management process will be described as Specific Example 1 of the alarm management process according to the embodiment. FIG. 8 is a diagram illustrating Specific Example 1 of the alarm management process according to the embodiment.

In Specific Example 1, the basic alarm management process that is a hybrid form of the alarm detecting function and an alarm receiving function based on an OPC UA A&C model that is an open interface will be described. In Specific Example 1, arranging OPC UA as a base in consideration of a future rate of employment in the field makes it possible to expect cost reduction in supporting addition of devices to be added in the future, enhancement in supporting security, etc. OPC UA A&C has a structure that is conscious of ISA18.2 and IEC 62682 that are alarm-related standards and therefore implement functional specifications that are accepted in a generic manner.

First of all, as for the alarm generation source 20 without the alarm function, as in the reference technique, the side of the plant control system has to include the alarm detection logic depending on collected process values, the status of communication, etc. The reference technique normalizes a detected alarm into a unique form; however, Specific Example 1 employs a system that makes a conversion into a form of an OPC UA A&C model and that makes a notification to a high-order alarm management system via the OPC UA interface. In Specific Example 1, employing the above-described system enables standardization of a normalization logic and the high-order alarm management system controls only alarms of the OPC UA A&C model and thus building a system is made efficient.

As illustrated in FIG. 8, as for the alarm generation source 20 without the alarm function, such as the sensor device 20A, the alarm management system 100 illustrated in Specific Example 1 detects an alarm A by the alarm detection driver based on a process value that is transmitted by the sensor device 20A, transmits an alarm (A&C) to the alarm managing function via the OPC UA A&C model normalization converter, receives the alarm A (A&C) using the alarm reception driver (OPC UA client) that the alarm managing function includes, makes a notification of the alarm A (A&C) by the alarm managing function, and displays the alarm A (A&C) to the operator O via the HMI.

Secondly, as for the alarm generation source 20 with the sophisticated alarm managing function, for example, a device in which OPC UA A&C is implemented, it is necessary to take an advantage of the aspect that leaving the alarm managing function to the device side or the OPC UA server side more makes it possible to utilize information contained in an important alarm that is obtained on the device side by utilizing the ability of the device. Thus, in Specific Example 1, as for the alarm generation source 20 with the sophisticated alarm managing function like that described above, the received alarm is used directly and, when the low-order alarm generation source does not comply with OPC UA, a system for conversion into an OPC UA A&C model is incorporated.

Furthermore, as illustrated in FIG. 8, as for the alarm generation source 20 with the alarm managing function, such as the control device 20B, other than an OPC UA server, in the alarm management system 100 illustrated in Specific Example 1, the control device 20B detects an alarm B, the alarm management system 100 receives the alarm B transmitted by the control device 20B using the alarm reception driver, converts the received alarm into an OPC UA A&C model via the OPC UA A&C normalization converter, receives an alarm B (A&C) using the alarm reception driver (OPC UA client) that the alarm managing function has, makes a notification of the alarm B (A&C) using the alarm managing function, and displays the alarm B (A&C) to the operator O via the HMI. As for the alarm generation source 20 with the sophisticated alarm function, such as the server device 20C, in the alarm management system 100 illustrated in Specific Example 1, the server device 20C that is the OPC UA server in which A&C is implemented detects an alarm C (A&C), the alarm management system 100 receives the alarm C (A&C) using the alarm reception driver (OPC UA client) that the alarm managing function has, makes a notification of the alarm C (A&C) using the alarm managing function, and displays the alarm C (A&C) to the operator O via the HMI.

As described above, Specific Example 1 that is the basic alarm management process makes it possible to build a hybrid system achieving treatment of both alarms for the two types of the alarm generation source 20.

### 3-6. Specific Example 2 of Alarm Management Process According to Embodiment

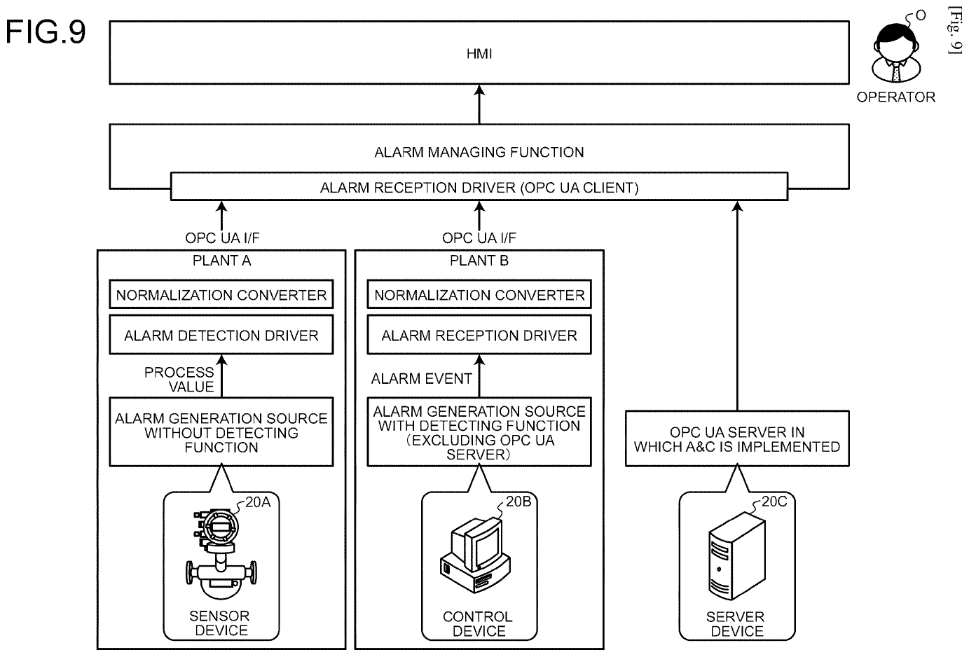

Using FIG. 9, an alarm management process in plants that are located in remote locations will be described as Specific Example 2 of the alarm management process according to the embodiment. FIG. 9 is a diagram illustrating Specific Example 2 of the alarm management process according to the embodiment.

In Specific Example 2, the alarm management process in which the alarm detecting function and the alarm receiving function are located in a distributed manner in plants that are set in remote locations will be described. In Specific Example 2, the driver functions are used in a form of an edge server and thus are located in a distributed manner in remote locations. In other words, in Specific Example 2, the alarm detection driver is located in a plant A and the alarm reception driver is located in a plant B, respectively. In Specific Example 2, because communication of interfaces between the drivers and the high-order alarm managing function is made using the OPC UA interfaces, location in remote locations is realized easily and secure communication is implemented easily.

As illustrated in FIG. 9, the alarm generation source 20 without the alarm function, such as the sensor device 20A, is set in the plant A. The alarm detection driver and the OPC UA A&C normalization converter are set in the plant A. The alarm management system 100 illustrated in Specific Example 2 detects an alarm A using the alarm detection driver based on a process value that is transmitted by the sensor device 20A, transmits an alarm A (A&C) to the alarm managing function via the OPC UA A&C model normalization converter and the OPC UA I/F, receives the alarm A (A&C) using the alarm reception driver (OPC UA client) that the alarm managing function has, makes a notification of the alarm A (A&C) using the alarm managing function, and displays the alarm A (A&C) to the operator O via the HMI.

Furthermore, as illustrated in FIG. 9, the alarm generation source 20 having the alarm function, such as the control device 20B, other than an OPC UA server is set in the plant B. The alarm reception driver and the OPC UA A&C normalization converter are also set in the plant B. In the alarm management system 100 illustrated in Specific Example 2, the control device 20B detects an alarm B, the alarm management system 100 receives the alarm B transmitted by the control device 20B using the alarm reception driver, converts the received alarm B into an OPC UA A&C model via the OPC UA A&C normalization converter, transmits an alarm B (A&C) to the alarm managing function via the OPC UA I/F, receives the alarm B (A&C) using the alarm reception driver (OPC UA client) that the alarm managing function has, makes a notification of the alarm B (A&C) using the alarm managing function, and displays the alarm B (A&C) to the operator O via the HMI.

As for the alarm generation source 20 with the sophisticated alarm function, such as the server device 20C, as in Specific Example 1, in the alarm management system 100 illustrated in Specific Example 2, the server device 20C that is an OPC UA server in which A&C is implemented detects an alarm C (A&C), the alarm management system 100 receives the alarm C (A&C) using the alarm reception driver (OPC UA client) that the alarm managing function has, makes a notification of the alarm C (A&C) using the alarm managing function, and displays the alarm C (A&C) to the operator O via the HMI.

### 3-7. Specific Example 3 of Alarm Management Process According to Embodiment

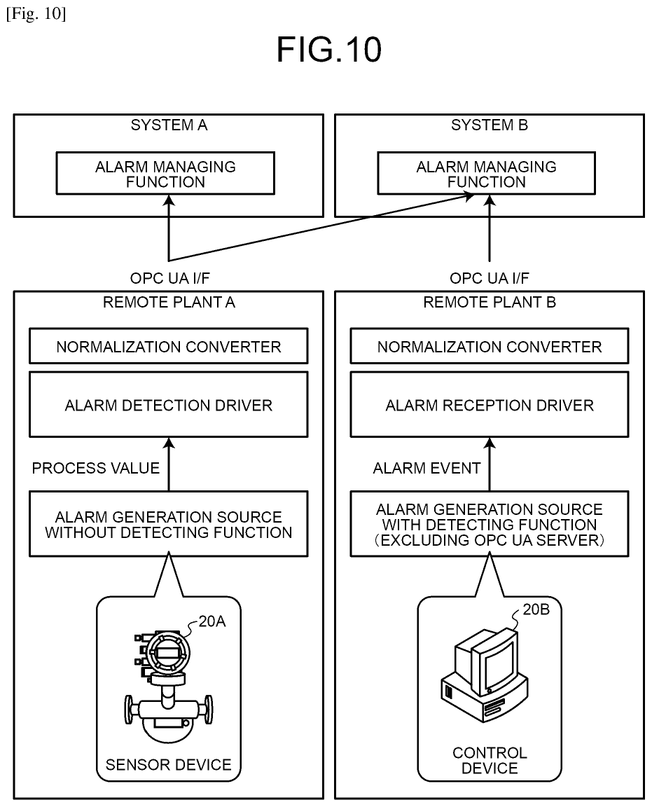

Using FIG. 10, an alarm management process corresponding to multi-client connection in plants that are located in a distributed manner in remote locations will be described as Specific Example 3 of the alarm management process according to the embodiment. FIG. 10 is a diagram illustrating Specific Example 3 of the alarm management process according to the embodiment.

In Specific Example 3, the alarm management process in which the alarm detecting function and the alarm receiving function are located in a distributed manner in plants that are set in remote locations and that uses multi-client connection will be described. In Specific Example 3, in addition to Specific Example 2, making the OPC UA I/Fs themselves meet multi-client connection makes it possible to link alarms between the plants that are located in remote locations and a plurality of systems. For this reason, in Specific Example 3, it is possible to distribute the same alarm to the systems and synchronize an alarm operation, such as checking an alarm, from each system between the systems.

As illustrated in FIG. 10, the alarm management system 100 illustrated in Specific Example 3 detects an alarm A using the alarm detection driver based on a process value that is transmitted by the sensor device 20A and transmits an alarm A (A&C) to the alarm managing function via the OPC UA A&C model normalization converter and the OPC UA I/F. In this case, in the alarm management system 100 illustrated in Specific Example 3, it is possible to transmit the alarm A (A&C) not only to the alarm managing function of the system A but also to the alarm managing function of the system B.

### 3-8. Specific Example 4 of Alarm Management Process According to Embodiment

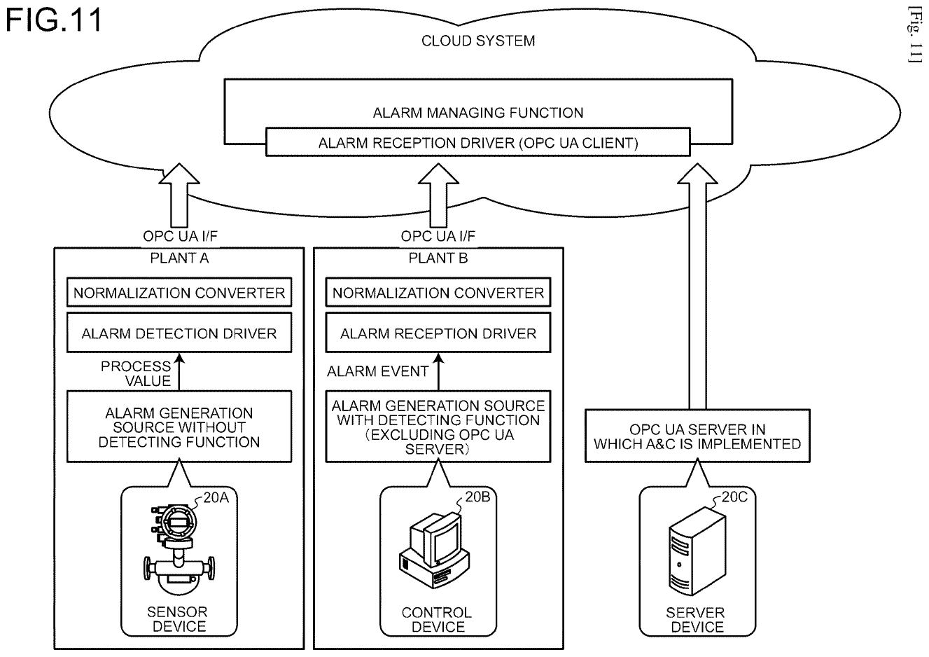

Using FIG. 11, an alarm management process using a cloud system in plants that are located in a distributed manner in remote locations will be described as Specific Example 4 of the alarm management process according to the embodiment. FIG. 11 is a diagram illustrating Specific Example 4 of the alarm management process according to the embodiment.

In Specific Example 4, the alarm management process in which the alarm detecting function and the alarm receiving function are located in a distributed manner in plants that are set in remote locations and the cloud system is used will be described. In Specific Example 4, in addition to Specific Example 2, it is possible to build a cloud system that is increasing rapidly. In other words, in Specific Example 4, in the configuration of Specific Example 2, only the alarm managing function may be caused to run as an application in the cloud system and an alarm may be transmitted to the side of the cloud system from the alarm detection driver and the alarm reception driver as from the plants in remote locations. For this reason, in Specific Example 4, complying with the OPC UA I/Fs makes it possible to replace the drivers and change the security policy without changing a program.

As illustrated in FIG. 11, the alarm management system 100 illustrated in Specific Example 4 is able to receive an alarm A (A&C) that is generated in the plant A based on a process value of the sensor device 20A, an alarm B (A&C) that is generated in the plant B based on an alarm B of the control device 20B, and an alarm C (A&C) that is generated by the server device 20C using the alarm reception driver (OPC UA client) that the alarm managing function that is built in the cloud system has.

### 4. Flow of Processes performed by Alarm Management System 100

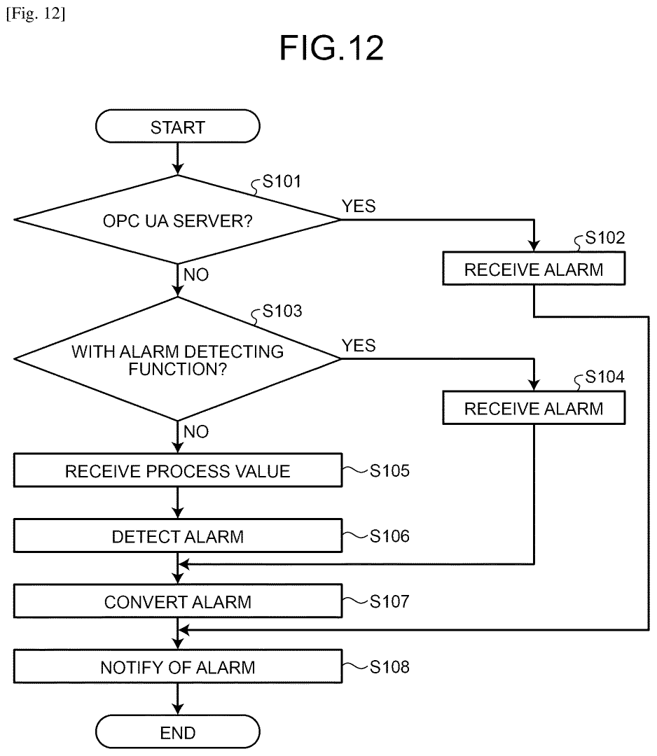

Using FIG. 12, a flow of the alarm management process according to the embodiment will be described. FIG. 12 is a flowchart illustrating an example of the flow of the alarm management process according to the embodiment. Note that the process of steps S101 to S108 described below may be executed in a different order. Among the process of steps S101 to S108 described below, there may be a step to be omitted.

When the alarm generation source 20 is an OPC UA server, such as the server device 20C (step S101: Yes), the alarm management apparatus 10 receives an alarm C (A&C) that is generated by the alarm generation source 20 (step S102), notifies the operator terminal device 30 of the received alarm C (A&C) (step S108), and ends the process.

When the alarm generation source 20 is not an OPC UA server (step S101: No) and the alarm generation source 20 is a device having the alarm detecting function, such as the control device 20B (step S103: Yes), the alarm management apparatus 10 receives an alarm B (step S104), converts the received alarm B into an OPC UA A&C model (step S107), notifies the operator terminal device 30 of the converted alarm B (A&C) (step S108), and ends the process.

When the alarm generation source 20 is not an OPC UA server (step S101: No) and the alarm generation source 20 is a device without the alarm detecting function, such as the sensor device 20A (step S103: No), the alarm management apparatus 10 receives a process value that is transmitted by the alarm generation source 20 (step S105), detects an alarm A based on the received process value (step S106), converts the detected alarm A into an OPC UA A&C model (step S107), notifies the operator terminal device 30 of the converted alarm A (A&C) (step S108), and ends the process.

### 5. Effects of Embodiment

Effects of the embodiment will be described lastly. Effects 1 to 9 corresponding to the processes according to the embodiment will be described below.

### 5-1. Effect 1

First of all, in the process according to the above-described embodiment, the alarm management apparatus 10 receives a first alarm that is generated by a first device complying with a given standard and information on an alarm that is transmitted by a second device not complying with the given standard, generates a second alarm in a data form complying with the given standard based on the information on the alarm when the information on the alarm is received, and notifies a given terminal device of the first alarm and the second alarm. Thus, according to the process, it is possible to manage the alarms effectively according to whether each device complies with the given standard.

### 5-2. Effect 2

Secondly, in the process according to the above-described embodiment, the alarm management apparatus 10 generates the second alarm based on data that is collected by the second device without an alarm detecting function and generates the second alarm by converting an alarm that is generated by the second device having the alarm detecting function into the data form. Thus, according to the process, it is possible to manage the alarms effectively according to whether each device has the alarm detecting function.

### 5-3. Effect 3

Thirdly, in the process according to the above-described embodiment, the given standard is OPC UA A&C. Thus, according to the process, it is possible to manage the alarms effectively for devices supported by the OPC UA interface.

### 5-4. Effect 4

Fourthly, in the process according to the above-described embodiment, the alarm management apparatus 10 notifies the given terminal device that displays the first alarm and the second alarm via an alarm notification interface complying with the given standard. Thus, according to the process, it is possible to effectively manage the alarm that is generated by the first device complying with the given standard via the driver and the interface complying with the given standard.

### 5-5. Effect 5

Fifthly, in the process according to the above-described embodiment, when the data that is collected by the second device without the alarm detecting function is received, the alarm management apparatus 10 detects an alarm when the data exceeds a given threshold via an alarm detection driver complying with the given standard and generates the second alarm by converting the detected alarm into the data form complying with the given standard via a normalization converter complying with the given standard. Thus, according to the process, it is possible to effectively manage the alarm based on the data that is collected by the second device without the alarm detecting function via the driver and the interface complying with the given standard.

### 5-6. Effect 6

Sixthly, in the process according to the above-described embodiment, when the alarm that is generated by the second device having the alarm detecting function is received, the alarm management apparatus 10 generates the second alarm by converting the received alarm into the data form complying with the given standard via a normalization converter complying with the given standard. Thus, according to the process, it is possible to effectively manage the alarm that is generated by the second device having the alarm detecting function via the driver and the interface complying with the given standard.

### 5-7. Effect 7

Seventhly, in the process according to the above-described embodiment, the first device is a device that, when a process value in a plant exceeds a given threshold, generates the first alarm in the data form complying with the given standard. According to the process, it is possible to effectively manage the alarm that is generated by the first device complying with the given standard based on the process value in the plant.

### 5-8. Effect 8

Eighthly, in the process according to the above-described embodiment, the second device without the alarm detection function is a device that collects a process value in a plant. According to the process, it is possible to effectively manage the alarm that is generated based on the process value that is collected in the plant by the second device not complying with the given standard.

### 5-9. Effect 9

Ninthly, in the process according to the above-described embodiment, the second device having the alarm detection function is a device that generates an alarm in a data form different from the data form complying with the given standard when a process value in a plant exceeds a given threshold. According to the process, it is possible to effectively manage the alarm that is generated by the second device not complying with the given standard based on the process value in the plant.

### System

The process procedure, control procedure, specific names, and information including various types of data and parameters that are presented in the description above and the drawings are changeable freely unless otherwise noted.

Each component of each device illustrated in the drawings is a functional idea and need not necessarily be configured physically as illustrated in the drawings. In other words, specific modes of distribution and integration of devices are not limited to those illustrated in the drawings. In other words, all or part of the devices can be configured by functional or physical distribution or integration in any unit according to various types of load and usage.

Furthermore, all or given part of each processing function implemented by each device can be realized by a CPU and a program that is analyzed and executed by the CPU or can be realized as hardware according to a wired logic.

### Hardware

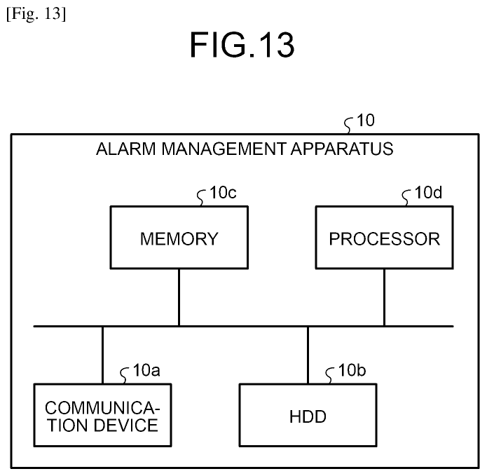

An example of a hardware configuration of the alarm management apparatus 10 that is an alarm management apparatus will be described next. FIG. 13 is a diagram illustrating the example of the hardware configuration according to the embodiment. As illustrated in FIG. 13, the alarm management apparatus 10 includes a communication device 10a, a HDD (Hard Disk Drive) 10b, a memory 10c, and a processor 10d. The units illustrated in FIG. 13 are connected mutually by a bus, or the like.

The communication device 10a is a network interface card, or the like, and communicates with another server. The HDD 10b stores a program that causes the functions illustrated in FIG. 4 to be on and a database.

The processor 10d reads the program that executes the same process as that of each of the processors illustrated in FIG. 4 from the HDD 10b, or the like, and loads the program in the memory 10c, thereby running the process that implements each of the functions illustrated in FIG. 4, etc. For example, the process implements the same function as that of each of the processors that the alarm management apparatus 10 includes. Specifically, the processor 10d reads the program with the same functions as those of the receiver 13a, the generator 13b, the notifying unit 13c, etc., from the HDD 10b, or the like. The processor 10d then executes the process that executes the same processes as those performed by the receiver 13a, the generator 13b, the notifying unit 13c, etc.

As described above, the alarm management apparatus 10 operates as an apparatus that reads and executes a program, thereby executing various types of processing methods. The alarm management apparatus 10 reads the above-described program from a recording medium using a medium reading device and execute the read program, thereby enabling implementation of the same functions as those of the above-described embodiment. Other programs according to the embodiment are not limited to being executed by the alarm management apparatus 10. For example, the present invention is similarly applicable to the case where another computer or another server executes the program or the computer and the server execute the program cooperatively.

The program can be distributed via a network, such as the Internet. The program can be recorded in a computer-readable recording medium, such as a hard disk, a flexible disk (FD), a CD-ROM, a MO (Magneto-Optical disk), or a DVD (Digital Versatile Disc), can be read by a computer from the recording medium, and thus can be executed.

### Remarks

Some examples of combinations of technical features disclosed will be described below.

### REFERENCE SIGNS LIST

10 ALARM MANAGEMENT APPARATUS
11 COMMUNICATION UNIT
12 STORAGE UNIT
13 CONTROLLER
13a RECEIVER
13b GENERATOR
13c NOTIFYING UNIT
20 ALARM GENERATION SOURCE
20A SENSOR DEVICE
20B CONTROL DEVICE
20C SERVER DEVICE
30 OPERATOR TERMINAL DEVICE
100 ALARM MANAGEMENT SYSTEM

1. An alarm management apparatus comprising:
a processor configured to:
receive a first alarm that is generated by a first device complying with a given standard and information on an alarm that is transmitted by a second device not complying with the given standard;
generate a second alarm in a data form complying with the given standard based on the information on the alarm when the information on the alarm is received; and
notify a given terminal device of the first alarm and the second alarm.

2. The alarm management apparatus according to claim 1, wherein
the processor is configured to generate the second alarm based on data that is collected by the second device without an alarm detecting function and generates the second alarm by converting an alarm that is generated by the second device having the alarm detecting function into the data form.

3. The alarm management apparatus according to claim 1, wherein
the given standard is OPC UA A&C (Open Platform Communications Unified Architecture Alarm and Conditions).

4. The alarm management apparatus according to claim 1, wherein
the processor is configured to notify the given terminal device that displays the first alarm and the second alarm via an alarm notification interface complying with the given standard.

5. The alarm management apparatus according to claim 2, wherein,
when the data that is collected by the second device without the alarm detecting function is received,
the processor is configured to detect an alarm when the data exceeds a given threshold via an alarm detection driver complying with the given standard and generate the second alarm by converting the detected alarm into the data form via a normalization converter complying with the given standard.

6. The alarm management apparatus according to claim 2, wherein,
when the alarm that is generated by the second device having the alarm detecting function is received,
the processor is configured to generate the second alarm by converting the received alarm into the data form via a normalization converter complying with the given standard.

7. The alarm management apparatus according to claim 1, wherein,
when a process value in a plant exceeds a given threshold, the first device generates the first alarm in the data form.

8. The alarm management apparatus according to claim 2, wherein
the second device without the alarm detection function is a device that collects a process value in a plant.

9. The alarm management apparatus according to claim 2, wherein,
the second device having the alarm detection function is a device that generates an alarm in a data form different from the data form when a process value in a plant exceeds a given threshold.

10. An alarm management method in which a computer executes a process comprising:
receiving a first alarm that is generated by a first device complying with a given standard and information on an alarm that is transmitted by a second device not complying with the given standard;
generating a second alarm in a data form complying with the given standard based on the information on the alarm when the information on the alarm is received; and
notifying a given terminal device of the first alarm and the second alarm.

11. A non-transitory computer-readable recording medium storing therein an alarm management program that causes a computer to execute a process comprising:
receiving a first alarm that is generated by a first device complying with a given standard and information on an alarm that is transmitted by a second device not complying with the given standard;
generating a second alarm in a data form complying with the given standard based on the information on the alarm when the information on the alarm is received; and
notifying a given terminal device of the first alarm and the second alarm.
